(19) United States
(12) Patent Application Publication
(10) Pub. No.: US 2019/0129186 A1
(43) Pub. Date: May 2, 2019

(54) C-Again Sight Wear

(71) Applicant: Cedric Leonard Atkins, Burteson, TX (US)

(72) Inventor: Cedric Leonard Atkins, Burteson, TX (US)

(21) Appl. No.: 15/801,027

(22) Filed: Nov. 1, 2017

(51) Int. Cl. G02B 27/01; G02C 11/00

(52) U.S. Cl. CPC G02B 27/0189; G02C 11/10; G02B 27/0172; G02B 2027/0141; G02B 2027/014; G02B 2027/0123; G02B 2027/0138; G02B 2027/0178

(57) ABSTRACT

The SDAP-View technology capabilities herein/here forth are embedded within the frames design and the lenses, as well as, the ability to supply power by harnessing energy through built in solar panels in the solar rapped frames. Once the glasses are switched on, a voice command can control data recording options; this is accomplished over Bluetooth technology. The built in microphone allows you to control connectivity thru Bluetooth to your phone or any hands free device available once paired with the glasses. The easy on screen menu allows easy access to your settings and apps. Information captured can be stored on an usb storage stick that's detachable from the arm of the frame for later retrieval on a pc or other devices.

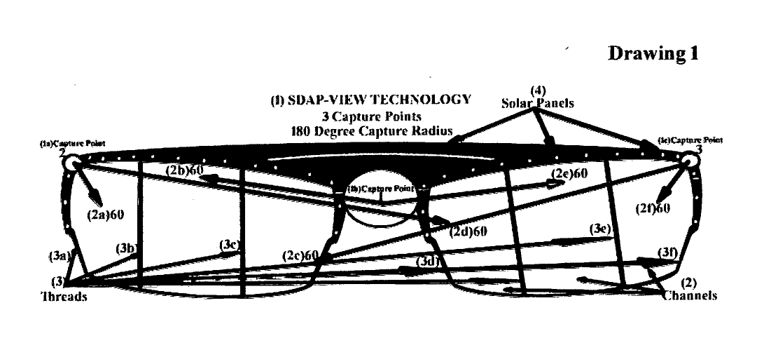

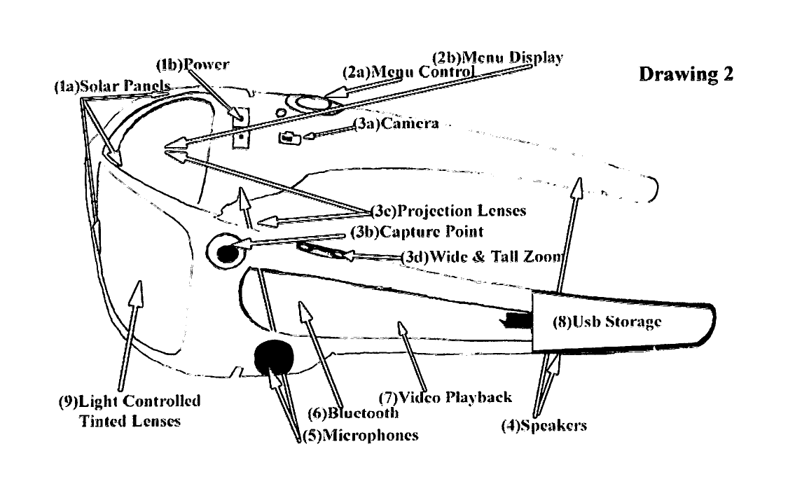

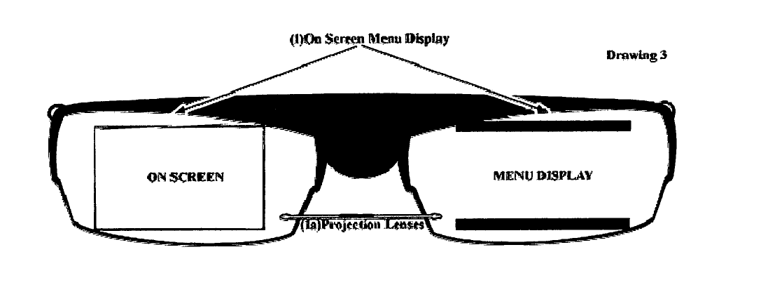

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF INVENTION

The loss of vision in one eye is the field of endeavor to which this invention pertains. I myself suffer from the complete loss of vision in my left eye, due to unknown reasons. After years of looking for solutions I found none that could help me or others with this problem. No other technology exists that specifically addresses this problem.

### BRIEF SUMMARY OF THE INVENTION

In Summary this is by no means a replacement for lost vision but merely a new adaptation for the user that will give them the confidence and security of having both the central area of focus and peripheral vision together again, this is called SDAP VIEW Technology (Simultaneous-Direct and Peripheral Views)

### BRIEF DESCRIPTION OF THE SEVERAL VIEWS OF THE DRAWING

Drawing 1 depicts a frontal view of the invention.

Drawing 2 depicts a side view of the invention.

Drawing 3 depicts a rear view of the invention.

### DETAILED DESCRIPTION OF THE INVENTION

CAGAIN Sight Wear glasses capture a full 180 degree visual radius and present it thru a complete redistribution of threads and channels (see drawing 1: #(3 Threads) #(2 Channels)). The technology necessary to fulfill the direction of the capture is called SDAP VIEW Technology (Simultaneous-Direct and Peripheral Views) (see drawing 1: #(1 SDAP-View Technology)) defined as having both the central area of focus and peripheral vision together again. SDAP Views are accomplished through capturing live video feed signals from 3 different capture points (see drawing 1: #(1a)#(1b)#(1c)) of 60 degree visual coverage radius (see drawing 1: #(2a)#(2b)#(2c)#(2d)#(2e)#(2f)) and sending the 3 independent signals back out as one live video output signal to a projection lens (see drawing 2: #(3c) for viewing as a complete 180 degree live stream. CAGAIN has 3 capture points (see drawing 1: #1 #(1a)#(1b)#(1c)) which are positioned to simultaneously capture and process the immediate and entire 180 degree visual radius in direct view. By capture points 1, 2, & 3 (see drawing 1: #(1a)#(1b)#(1c)) individually collecting data from a 60 degree visual angle of its direct path and then simultaneously sending the data thru threads to its perspective 60 degree portion of the assigned channel (see drawing 1: #(2a)#(2b)#(2c)#(2d)#(2e)#(2f)) in the projection lenses (see drawing 2: #(3c)), this creates a full view of the entire 180 degree visual coverage radius in both lenses (This is SDAP-VIEW TECHNOLOGY). All of the technology capabilities herein/here forth are embedded within the frames design and the lenses, as well as, the ability to supply power by harnessing energy through built in solar panels in the solar rapped frames (see drawing 2: #(1a)). Once the glasses are switched on (see drawing 2: #(1b) Power), a voice command can control data recording options, this is accomplished over Bluetooth technology (See drawing 2: #(6)). The built in microphone (see drawing 2: #(5)), allows you to control connectivity thru Bluetooth to your phone or any hands free device available once paired with the glasses. The easy on screen menu (see drawing 3: #(1) also sees drawing 2: #2#(2a) #(2b)), allows easy access to your settings and apps. Information captured can be stored on an usb storage stick (see drawing 2: #(8)), that's detachable from the arm of the frame for later retrieval on a pc or other devices.

1. The data collected by the 3 capture points when projected back creates the same visual experience that a person with 20/20 vision in both Eyes should experience. CAGAIN Sight Wear when in the off position are just normal glasses or shades, not until you power them on and choose your mode of live, record or stored data, can you access their many features and functions. These glasses require no type of medical procedure or prescription to work, simply turn them on; put them on and CAGAIN. This is called SDAP VIEW Technology (Simultaneous-Direct and Peripheral Views) This addresses and solves the problem brought on by the loss of vision in one eye.
